(19) United States
(12) Patent Application Publication
(10) Pub. No.: US 2021/0154756 A1
(43) Pub. Date: May 27, 2021

(54) RECIPROCATING SAW

(71) Applicant: Guangwei REN, Zhengzhou (CN)

(72) Inventor: Guangwei REN, Zhengzhou (CN)

(21) Appl. No.: 17/169,476

(22) Filed: Feb. 7, 2021

Related U.S. Application Data
(63) Continuation-in-part of application No. PCT/CN2019/098933, filed on Aug. 1, 2019.

(30) Foreign Application Priority Data
Aug. 21, 2018 (CN) 201810951707.9
Aug. 21, 2018 (CN) 201821345033.X

(51) Int. Cl. B23D 51/16; B23D 51/02; B23D 51/04

(52) U.S. Cl. CPC B23D 51/16; B23D 51/04; B23D 51/025

(57) ABSTRACT

A reciprocating saw includes a frame, a motor, a belt pulley, a reciprocating block, a guide pillar, a driving belt, two guide blocks, two sliding blocks, two clamps, a saw blade, a base, a mounting rack, a driving wheel, a connecting rod, a fixed rod, and a plurality of pulleys. The frame includes a first side, a second side opposite to the first side, and a third side connecting the first side and the second side. The mounting rack is disposed between the first side and the second side. The motor and the belt pulley are disposed on the mounting rack. The motor includes a motor shaft and the driving wheel is disposed on the motor shaft. The belt pulley is connected to the driving wheel through a belt. The connecting rod includes a first end hinged to the belt pulley and a second end hinged to the reciprocating block.

### CROSS-REFERENCE TO RELATED APPLICATIONS

This application is a continuation-in-part of International Patent Application No. PCT/CN2019/098933 with an international filing date of Aug. 1, 2019, designating the United States, now pending, and further claims foreign priority benefits to Chinese Patent Application No. 201810951707.9 filed Aug. 21, 2018, and to Chinese Patent Application No. 201821345033.X filed Aug. 21, 2018. The contents of all of the aforementioned applications, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to a reciprocating saw.

A reciprocating saw is a type of engine-powered saw in which the cutting action is achieved through a push-and-pull (“reciprocating”) motion of the blade.

The reciprocating saws include jigsaws, saber saws, scroll saws, bow saws, and so on. The jigsaws and the saber saws have a short cutting stroke and require specific blades. The scroll saws are energy-intensive, and the movement of the blades tends to deviate from preset angles, leading to inaccurate cutting. The bow saws are bulky and also energy-intensive, with a slow cutting speed.

### SUMMARY

The disclosure provides a reciprocating saw, comprising a frame, a motor, a belt pulley, a reciprocating block, a guide pillar, a driving belt, two guide blocks, two sliding blocks, two clamps, a saw blade, a base, a mounting rack, a driving wheel, a connecting rod, a fixed rod, and a plurality of pulleys. The frame comprises a first side, a second side opposite to the first side, and a third side connecting the first side and the second side; the mounting rack is disposed between the first side and the second side; the motor and the belt pulley are disposed on the mounting rack; the motor comprises a motor shaft and the driving wheel is disposed on the motor shaft; the belt pulley is connected to the driving wheel through a belt in a transmission way; the connecting rod comprises a first end hinged to the belt pulley and a second end hinged to the reciprocating block; the reciprocating block is movable on the guide pillar; the fixed rod is disposed between the frame and the mounting rack to fix the guide pillar; the reciprocating block is fixed on the driving belt; the driving belt winds around the plurality of pulleys; two ends of the driving belt are fixed on the two sliding blocks, respectively; the two guide blocks are disposed on one end of the first side and on one end of the second side, respectively, and are opposite to each other; the two sliding blocks are slidable on the two guide blocks, respectively; the two clamps are disposed on the two sliding blocks, respectively; two ends of the saw blade are fixed on the two clamps, respectively; the driving belt, the two sliding blocks, the two clamps and the saw blade form a closed loop; and the frame is fixed on the base.

In a class of this embodiment, the reciprocating saw further comprises a tensioner disposed on one of the plurality of pulleys; the tensioner comprises a tensioning frame, a shaft lever, and a thumb screw; the tensioning frame is U-shaped; two ends of the tensioning frame are fixed between the one of the plurality of pulleys and the frame via the shaft lever; the frame comprises a strip hole and the shaft lever is disposed in the strip hole; the thumb screw disposed through the tensioning frame, and one end of the thumb screw abuts against the frame.

In a class of this embodiment, the reciprocating saw further comprises an operation platform and a support pillar; the operation platform is supported by the support pillar and is fixed on the base; and the operation platform comprises an elongated slot; the saw blade is movable in the elongated slot to saw a workpiece.

In a class of this embodiment, two spring are disposed around the two guide blocks, respectively; and the two springs are disposed between the two sliding blocks and the frame, respectively.

In a class of this embodiment, the belt pulley is directly connected to the motor shaft; and the connecting rod is disposed between the belt pulley and the reciprocating block.

In a class of this embodiment, the base comprises a clamping part; the clamping part comprises two plates opposite to each other; each plate comprises a first through hole; the frame comprises a second through hole; the first through hole is aligned with the second through hole; a pin is disposed in the first through hole and the second through hole to fix the frame on the base; and the frame is rotatable with respect to the base with the pin as a pivot point.

In a class of this embodiment, the reciprocating saw further comprises two flanges disposed on the base; the first side and the second side are two vertical columns, and the two vertical columns are disposed on the two flanges, respectively; each of the two vertical columns comprises a fixed part and a movable part disposed around the fixed part; the moveable part is moveable with respect to the fixed part; and the two sliding sleeves are disposed on two movable parts, respectively.

In a class of this embodiment, the driving belt comprises steel or plastic, or a combination thereof; and a cross section of the driving belt is circular, triangular, or trapezoid.

The following advantages are associated with the reciprocating saw of the disclosure. The reciprocating saw of the disclosure is compact, and the saw blade can be disposed parallel to the ground or vertically to the ground, so that the reciprocating saw can operate in various cutting modes. The tension of the driving belt is adjustable through the tensioner, ensuring the cutting accuracy of the reciprocating saw. The frame is rotatable with respect to the base, so it has a large cutting stroke. The saw blade is clamped by two clamps, so it is easy to replace, and the reciprocating saw is adapted to cut various workpiece with different shapes and materials.

### BRIEF DESCRIPTION OF THE DRAWINGS

FIG. 1 is a schematic diagram of a reciprocating saw in accordance with a first embodiment of the disclosure;

FIG. 2 is a side view of a reciprocating saw in FIG. 1;

FIG. 3 shows a transmission mode of a reciprocating saw in accordance with one embodiment of the disclosure;

FIG. 4 is a schematic diagram of a tensioner of a reciprocating saw in accordance with one embodiment of the disclosure;

FIG. 5 is a schematic diagram of a sliding block and adjacent elements thereof of a reciprocating saw in accordance with one embodiment of the disclosure;

FIG. 6 is a schematic diagram of a base of a reciprocating saw in accordance with one embodiment of the disclosure;

FIG. 7 is a front view of a clamp of a reciprocating saw in accordance with a first embodiment of the disclosure;

FIG. 8 is a side view of a clamp of a reciprocating saw in accordance with a first embodiment of the disclosure;

FIG. 9 is a front view of a clamp of a reciprocating saw in accordance with a second embodiment of the disclosure;

FIG. 10 is a side view of a clamp of a reciprocating saw in accordance with a second embodiment of the disclosure;

FIG. 11 is a top view of a clamp of a reciprocating saw in accordance with a second embodiment of the disclosure;

FIG. 12 is a schematic diagram of a reciprocating saw in accordance with a second embodiment of the disclosure;

FIG. 13 is a top view of a reciprocating saw in FIG. 12;

FIG. 14 is a schematic diagram of a reciprocating saw in accordance with a third embodiment of the disclosure; and

FIG. 15 is a side view of a reciprocating saw in FIG. 14.

In the drawings, the following reference numbers are used: 1. Frame; 2. Mounting rack; 3. Base; 4. Motor; 5. Belt pulley; 6. Connecting rod; 7. Guide pillar; 8. Reciprocating block; 9. Belt; 10. Driving belt; 11. Pulley; 12. Tensioning frame; 13. Sliding block; 14. Guide block; 15. Clamp; 16. Saw blade; 17. Shaft lever; 18. Thumb screw; 19. Fixed rod; 20. Clamping part; 21. Driving wheel; 22. Motor support; 23. Operation platform; 24. Support pillar; 25. Spring; 26. Vertical column; 27. Sliding sleeve; 28. Flange; 29. Fastener; 30. Pin.

### DETAILED DESCRIPTION

To further illustrate, embodiments detailing a reciprocating saw are described below. It should be noted that the following embodiments are intended to describe and not to limit the disclosure.

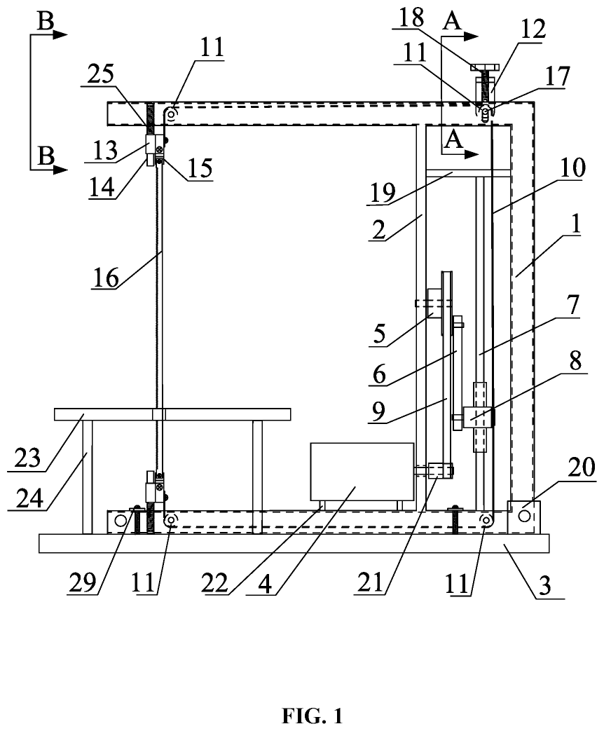

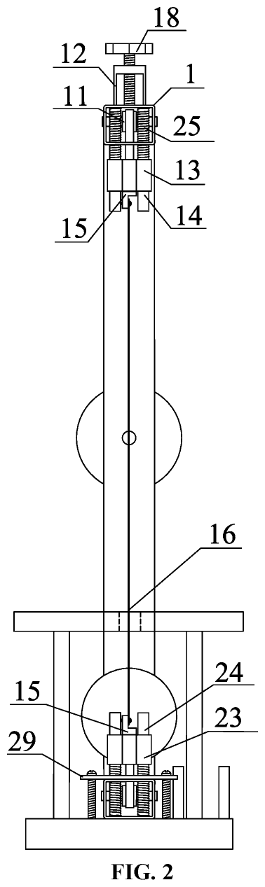

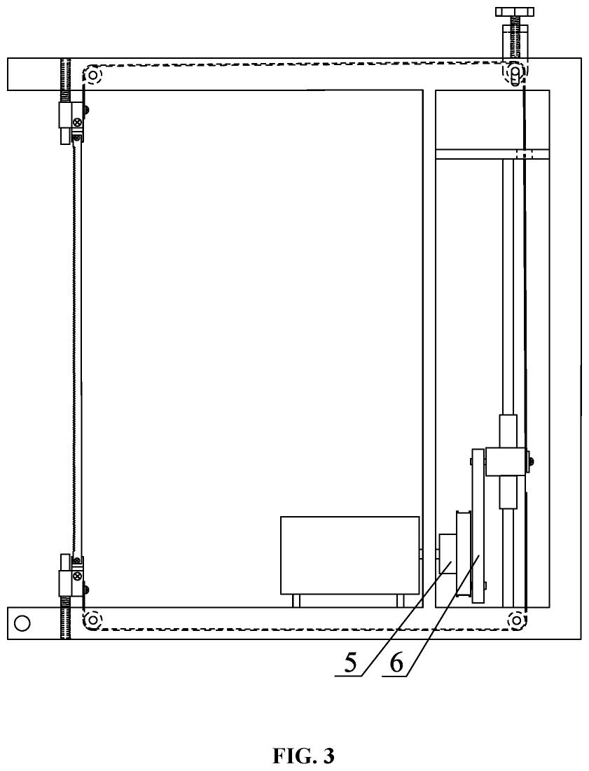

As shown in FIGS. 1 and 2, the disclosure provides a reciprocating saw comprising a C-shaped frame 1 and a base 3. The C-shaped frame 1 is tubular and comprises a first side, a second side opposite to the first side, and a third side connecting the first side and the second side. A mounting rack 2 is disposed between the first side and the second side and close to the third side. A motor 4 and a belt pulley 5 are disposed on the mounting rack 2. The motor support 22 is disposed on the frame 1 to support the motor 4. The motor 4 comprises a motor shaft and a driving wheel 21 is disposed on the motor shaft. The belt pulley 5 and the driving wheel 21 are disposed on the same side of the mounting rack 2. The power output by the motor is transmitted to the driving wheel 21. The driving wheel drives the belt pulley 5 to rotate through the belt 9. The transmission mode is intended to reduce the speed output by the motor. At present, there are many kinds of motors, including the motors with a reducer. If a motor with a reducer is used, as shown in FIG. 3, the motor shaft is directly connected to the belt pulley 5. A connecting rod 6 is disposed on the outer edge of the belt pulley 5. The connecting rod 6 comprises a first end hinged to the belt pulley 5 and a second end hinged to the reciprocating block 8; the reciprocating block 8 is movable on the guide pillar 7. When the belt pulley 5 is rotating, the connecting rod 6 drives the reciprocating block 8 to move on the guide pillar 7 back and forth. The guide pillar 7 is disposed between the fixed rod 19 and the frame 1 so as to leave sufficient space for installation and adjustment of a tensioner for tensioning a driving belt disposed above the guide pillar 7.

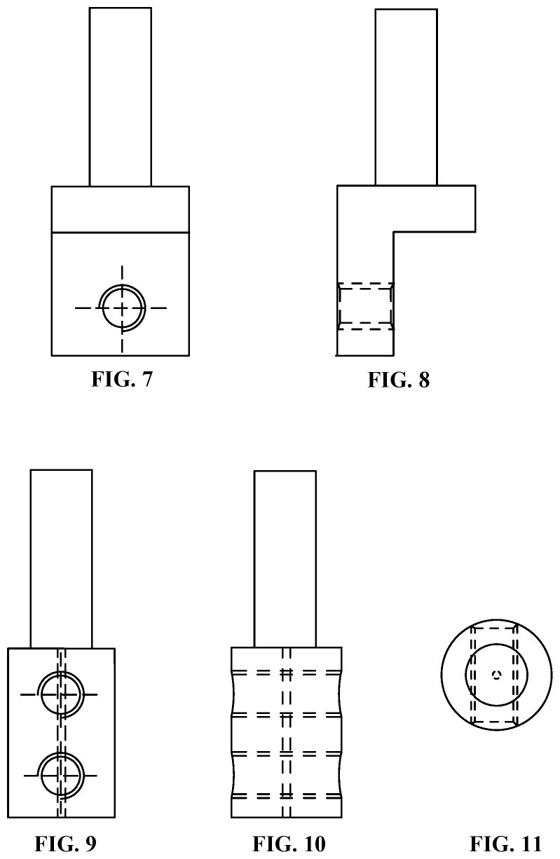

To ensure the reciprocating motion of the saw blade, the reciprocating saw is connected to a flat driving belt 10. Optionally, the cross section of the driving belt is circular, triangular, or trapezoid, and the driving belt 10 comprises steel or plastic, or a combination thereof. Part of the driving belt 10 is fixed on the reciprocating block 8, part is wound around four pulleys 11 disposed on the frame, and two ends of the driving belt 10 are fixed on two sliding blocks 13, respectively. as shown in FIG. 5, two guide blocks 14 are disposed on one end of the first side and on one end of the second side, respectively, and are opposite to each other; the two sliding blocks 13 are slidable on the two guide blocks 14, respectively. To increase the restoring force of the sliding blocks, two spring 25 are disposed around the two guide blocks 14, respectively; and the two springs 25 are disposed between the two sliding blocks 13 and the frame 1, respectively. Two clamps 15 are disposed on the two sliding blocks 13, respectively; two ends of the saw blade 16 are fixed on the two clamps, respectively. The clamps 15 are rotatably connected to the two sliding blocks 13, so that the saw blade is rotatable at 360°. As shown in FIGS. 7 and 8, the reciprocating saw employs a flat saw blade or abrasive stick. As shown in FIGS. 9-11, the reciprocating saw employs a linear saw blade or abrasive stick.

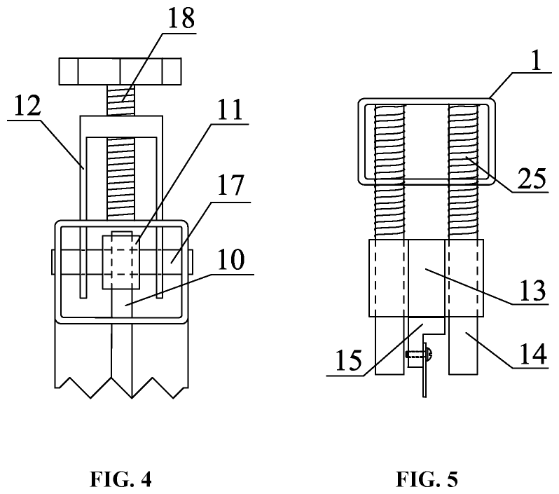

To prevent the driving belt from loosening after long-time use and to facilitate the replacement of the saw blade, a tensioner is disposed on the frame. Theoretically, the tensioner can be disposed on any one of the four pulleys on the frame. In certain embodiments, the tensioner is disposed on the pulley 11 above the fixed rod 19. As shown in FIG. 4, the tensioner comprises a tensioning frame 12, a shaft lever 17, and a thumb screw 18; the tensioning frame 12 is U-shaped; two ends of the tensioning frame 12 are fixed between the pulley 11 and the frame 1 via the shaft lever; the frame comprises a strip hole and the shaft lever is disposed in the strip hole; the thumb screw 18 disposed through the tensioning frame, and one end of the thumb screw abuts against the frame. By rotating the thumb screw 18, the tensioning frame 12, the shaft lever 17 and the pulley 11 are driven to move as a whole, so as to tension or loosen the driving belt.

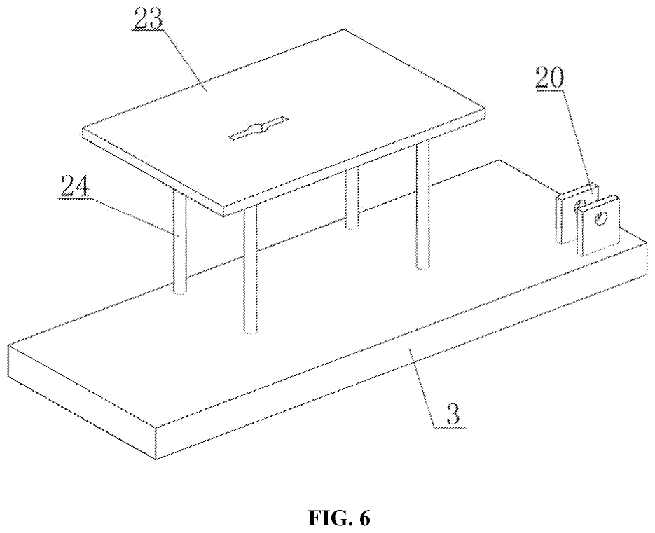

In certain embodiments, as shown in FIGS. 1, 2, and 6, the frame 1 is fixed on the base 3 via two fasteners 29. Four supports pillars are disposed on the base 3 and the operation platform 23 is disposed on the four support pillars. The operation platform comprises an elongated slot; the saw blade is movable in the elongated slot to saw a workpiece. In another embodiment, the base comprises a clamping part 20; the clamping part comprises two plates opposite to each other; each plate comprises a first through hole.

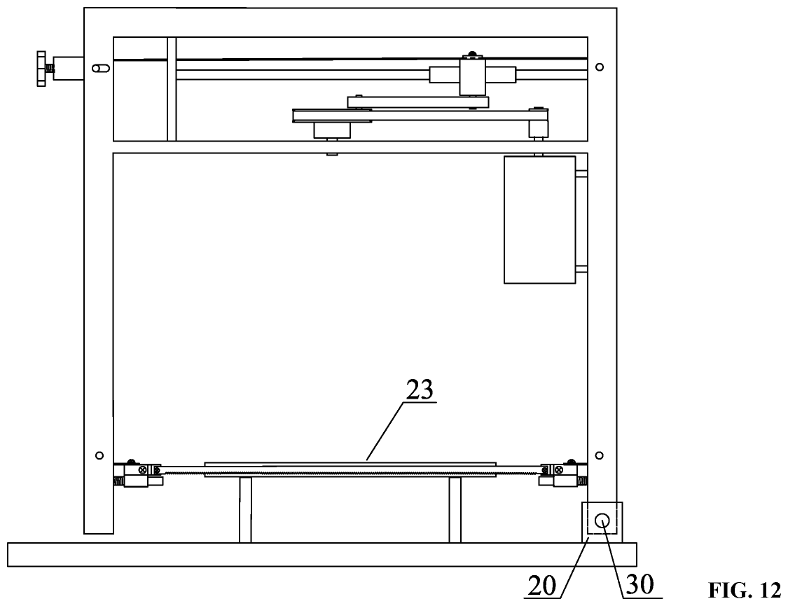

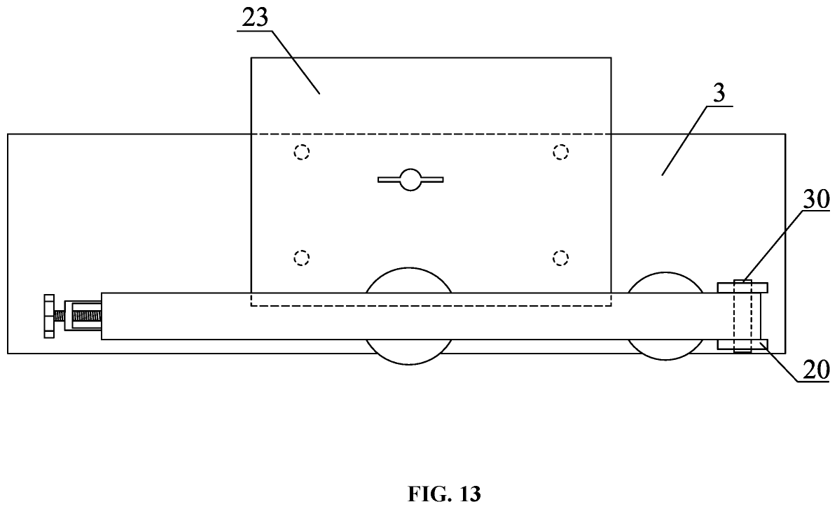

As shown in FIGS. 12 and 13, the frame comprises a second through hole; the first through hole is aligned with the second through hole; a pin 30 is disposed in the first through hole and the second through hole to fix the frame on the base, and the frame is rotatable with respect to the base with the pin 30 as a pivot point, which facilitates the cutting of a workpiece on the operation platform 30.

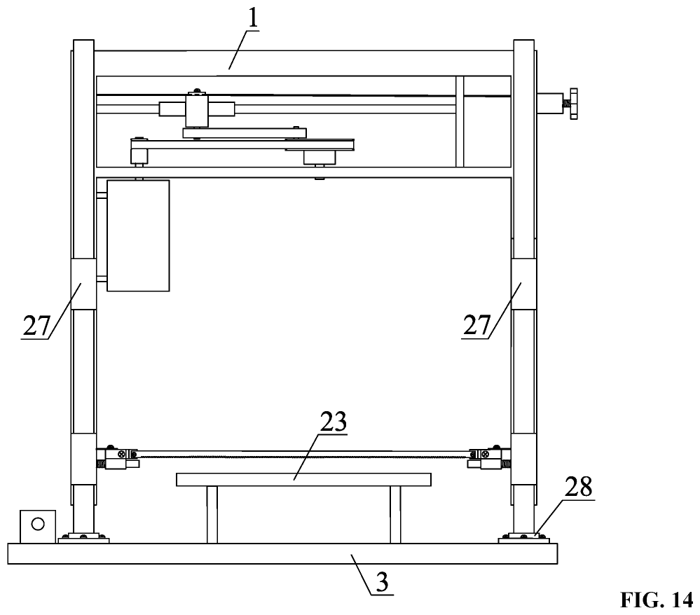

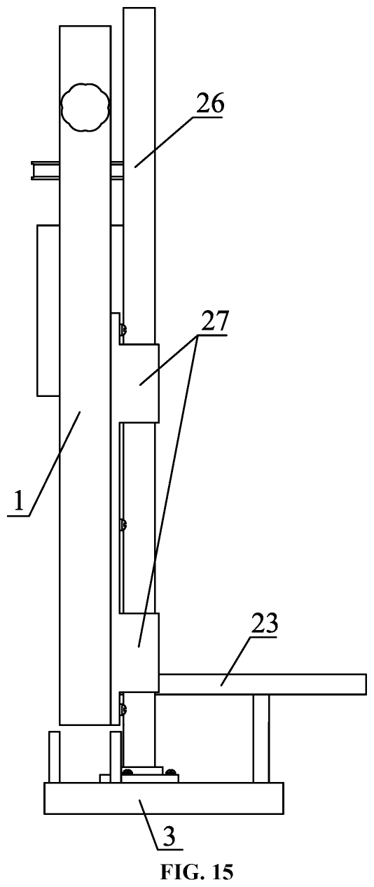

In certain embodiments, as shown in FIGS. 14 and 15, the reciprocating saw further comprises two flanges 28 disposed on the base 3; the first side and the second side are two vertical columns 26, and the two vertical columns 26 are disposed on the two flanges 28, respectively. Each of the two vertical columns 26 comprises a fixed part and a movable part disposed around the fixed part. The moveable part is moveable with respect to the fixed part. The two sliding sleeves 27 are disposed on the movable parts, respectively. In this way, the height of the frame with respect to the operation platform is adjustable.

The reciprocating saw of the disclosure is compact, and the saw blade can be disposed parallel to the ground or vertically to the ground, so that the reciprocating saw can operate in various cutting modes. The tension of the driving belt is adjustable through the tensioner, ensuring the cutting accuracy of the reciprocating saw. The frame is rotatable with respect to the base, so it has a large cutting stroke. The saw blade is clamped by two clamps, so it is easy to replace, and the reciprocating saw is adapted to cut various workpiece with different shapes and materials.

It will be obvious to those skilled in the art that changes and modifications may be made, and therefore, the aim in the appended claims is to cover all such changes and modifications.

What is claimed is:

1. A reciprocating saw, comprising:
a frame;
a motor;
a belt pulley;
a reciprocating block;
a guide pillar;
a driving belt;
two guide blocks;
two sliding blocks;
two clamps;
a saw blade;
a base;
a mounting rack;
a driving wheel;
a connecting rod;
a fixed rod; and
a plurality of pulleys;
wherein:
the frame comprises a first side, a second side opposite to the first side, and a third side connecting the first side and the second side;
the mounting rack is disposed between the first side and the second side;
the motor and the belt pulley are disposed on the mounting rack;
the motor comprises a motor shaft and the driving wheel is disposed on the motor shaft;
the belt pulley is connected to the driving wheel through a belt in a transmission way;
the connecting rod comprises a first end hinged to the belt pulley and a second end hinged to the reciprocating block; the reciprocating block is movable on the guide pillar;
the fixed rod is disposed between the frame and the mounting rack to fix the guide pillar;
the reciprocating block is fixed on the driving belt;
the driving belt winds around the plurality of pulleys;
two ends of the driving belt are fixed on the two sliding blocks, respectively;
the two guide blocks are disposed on one end of the first side and on one end of the second side, respectively, and are opposite to each other; the two sliding blocks are slidable on the two guide blocks, respectively;
the two clamps are disposed on the two sliding blocks, respectively; two ends of the saw blade are fixed on the two clamps, respectively;
the driving belt, the two sliding blocks, the two clamps, and the saw blade form a closed loop; and
the frame is fixed on the base.

2. The reciprocating saw of claim 1, further comprising a tensioner disposed on one of the plurality of pulleys, wherein the tensioner comprises a tensioning frame, a shaft lever, and a thumb screw; the tensioning frame is U-shaped; two ends of the tensioning frame are fixed between the one of the plurality of pulleys and the frame via the shaft lever; the frame comprises a strip hole and the shaft lever is disposed in the strip hole; the thumb screw disposed through the tensioning frame, and one end of the thumb screw abuts against the frame.

3. The reciprocating saw of claim 1, further comprising an operation platform and a support pillar, wherein the operation platform is supported by the support pillar and is fixed on the base; and the operation platform comprises an elongated slot; the saw blade is movable in the elongated slot to saw a workpiece.

4. The reciprocating saw of claim 1, wherein two spring are disposed around the two guide blocks, respectively; and the two springs are disposed between the two sliding blocks and the frame, respectively.

5. The reciprocating saw of claim 1, wherein the belt pulley is directly connected to the motor shaft; and the connecting rod is disposed between the belt pulley and the reciprocating block.

6. The reciprocating saw of claim 1, wherein the base comprises a clamping part; the clamping part comprises two plates opposite to each other; each plate comprises a first through hole; the frame comprises a second through hole; the first through hole is aligned with the second through hole; a pin is disposed in the first through hole and the second through hole to fix the frame on the base; and the frame is rotatable with respect to the base with the pin as a pivot point.

7. The reciprocating saw of claim 1, further comprising two flanges disposed on the base; wherein the first side and the second side are two vertical columns, and the two vertical columns are disposed on the two flanges, respectively; each of the two vertical columns comprises a fixed part and a movable part disposed around the fixed part; the moveable part is moveable with respect to the fixed part; and two sliding sleeves are disposed on two movable parts, respectively.

8. The reciprocating saw of claim 1, wherein the driving belt comprises steel or plastic, or a combination thereof; and a cross section of the driving belt is circular, triangular, or trapezoid.
